(19) United States
(12) Patent Application Publication
(10) Pub. No.: US 2020/0074342 A1
(43) Pub. Date: Mar. 5, 2020

(54) QUESTION ANSWERING SYSTEM, QUESTION ANSWERING PROCESSING METHOD, AND QUESTION ANSWERING INTEGRATED SYSTEM

(71) Applicant: HITACHI, LTD., Tokyo (JP)

(72) Inventors: Shunta KARASAWA, Tokyo (JP); Mamoru SUEFUJI, Tokyo (JP); Hidenori KOSUGI, Tokyo (JP)

(73) Assignee: HITACHI, LTD., Tokyo (JP)

(21) Appl. No.: 16/421,850

(22) Filed: May 24, 2019

(30) Foreign Application Priority Data
Aug. 29, 2018 (JP) 2018-160416

(51) Int. Cl. G06N 20/00; G06N 5/04

(52) U.S. Cl. CPC G06N 20/00; G06N 5/04

(57) ABSTRACT

A question answering system for presenting an answer to an input question includes: a user input processing unit configured to receive the input question; a machine learning platform configured to generate question information for searching corresponding to the received input question by using a learned model for inferring question information from an input question; a word vector platform and an annotated question search platform configured to generate question information for searching corresponding to the received input question without using the learned model; an answer search processing unit configured to search for an answer corresponding to the question information by using the question information generated by at least one of the machine learning platform and the word vector platform/the annotated question search platform; and a dialog output processing unit configured to present the answer obtained through the searching.

### CROSS-REFERENCE TO PRIOR APPLICATION

This application relates to and claims the benefit of priority from Japanese Patent Application No. 2018-160416 filed on Aug. 29, 2018, the entire disclosure of which is incorporated herein by reference.

### BACKGROUND

The present invention relates to a question answering system and the like that receives an input of a question from a user and presents an answer to the question.

In recent years, a question answering system in which a user makes a question by inputting a question sentence or the like to the system and the system answers the question is used.

For example, U.S. Pat. No. 8,332,394 discloses a question answering system that decides a lexical answer type (LAT) to search for answer candidates, and analyzes the search results by using the LAT.

For example, if the question sentence is a single sentence such as “Could you tell me the height of Mt. Fuji?”, the question answering system can be constructed even by using conventional technology. However, for example, if a question answering system is to be constructed for operations of an estimation system, question sentences may be entered such as “I want to ask a question about the case search function. My affiliation has changed from month X and I fail to search for any case accordingly. What should I do now?”. Accordingly, it is necessary for the system to analyze the whole context of the multiple sentences to extract the intention of the question. Such a question answering system cannot be constructed by the conventional technology.

In recent years, it has become feasible to prepare a plurality of pieces of data (learning data) including questions and summaries of the questions, to perform machine learning, to receive an input of a question sentence to the results of the machine learning, and to output a summary of the question. It is possible to construct a question answering system that holds pairs of summaries of questions and answers as pieces of data and conducts a search by using the summary of a question as a key so as to specify and output an answer.

### SUMMARY

As mentioned above, with the machine learning technique, it is possible to construct a question answering system for responding to inquiries with multiple sentences. However, in the question answering system using machine learning, there are general problems of: (1) increasing an accuracy of answers even during the initial period after start-up of the system having less learning data; (2) reducing the preparation cost of the initial learning data upon the initial start-up of the system; (3) improving the accuracy of question answering at less learning cost while the system is in operation; and (4) achieving to eliminate over-learning. Accordingly, it is impossible to construct a practical question answering system with the mere machine learning technique.

The present invention has been made in view of the above circumstances, and an object thereof is to provide a technique capable of easily and appropriately providing an answer to a question input by a user.

In order to achieve the above object, a question answering system according to one aspect is a question answering system for presenting an answer to an input question that includes: a receiving unit configured to receive the input question; a first question information generating unit configured to generate question information for searching corresponding to the received input question by using a learned model for inferring question information from an input question; a second question information generating unit configured to generate question information for searching corresponding to the received input question without using the learned model; an answer search processing unit configured to search for an answer corresponding to the question information by using the question information generated by at least one of the first question information generating unit and the second question information generating unit; and a presentation unit configured to present the answer obtained through the searching.

According to the present invention, it is possible to easily and appropriately provide an answer to a question input by a user.

### BRIEF DESCRIPTION OF THE DRAWINGS

FIG. 1 is an overall configuration diagram of a computer system according to one embodiment.

FIG. 2 is a diagram for describing a data structure of an answer storage unit according to the embodiment.

FIG. 3 is a diagram for describing a data structure of a log in a log data storage unit according to the embodiment.

FIG. 4 is a diagram for describing a structure of teacher data in a teacher data storage unit according to the embodiment.

FIG. 5 is a diagram for describing learning data in a learning data storage unit according to the embodiment.

FIG. 6 is a diagram for describing an example of a question registered in a question storage unit according to the embodiment.

FIG. 7 is a diagram for describing an example of data registered in a dictionary storage unit according to the embodiment.

FIG. 8 is a diagram for describing an annotated question in an annotated question storage unit according to the embodiment.

FIG. 9 is a diagram for describing an example of a question about product specifications to be registered in the question storage unit according to the embodiment.

FIG. 10 is a diagram for describing an example of data for a question about product specifications to be registered in the dictionary storage unit according to the embodiment.

FIG. 11 is a diagram for describing an annotated question about product specifications in the annotated question storage unit according to the embodiment.

FIG. 12 is a flowchart of a question answering process according to the embodiment.

FIG. 13 is a flowchart of a question summary determination process according to the embodiment.

FIG. 14 is a flowchart of a question summary determination process with annotated question search according to the embodiment.

FIG. 15 is a flowchart of a product specification inquiry answering process according to the embodiment.

FIG. 16 is a flowchart of a question summary determination process with annotated question search according to the embodiment.

FIG. 17 is a flowchart of a machine learning process according to the embodiment.

FIG. 18 is a flowchart of an over-learning elimination process according to the embodiment.

FIG. 19 is an overall configuration diagram of a computer system according to a first modification.

FIG. 20 is a flowchart of overall processing according to the first modification.

FIG. 21 is a flowchart of a system takeover process according to a second modification.

### DETAILED DESCRIPTION OF THE EMBODIMENT

An embodiment will be described with reference to the drawings. It should be noted that the embodiment described below does not limit the invention relating to the claims, and all various elements described in the embodiment and combinations thereof are not necessarily essential for the means of resolving the invention.

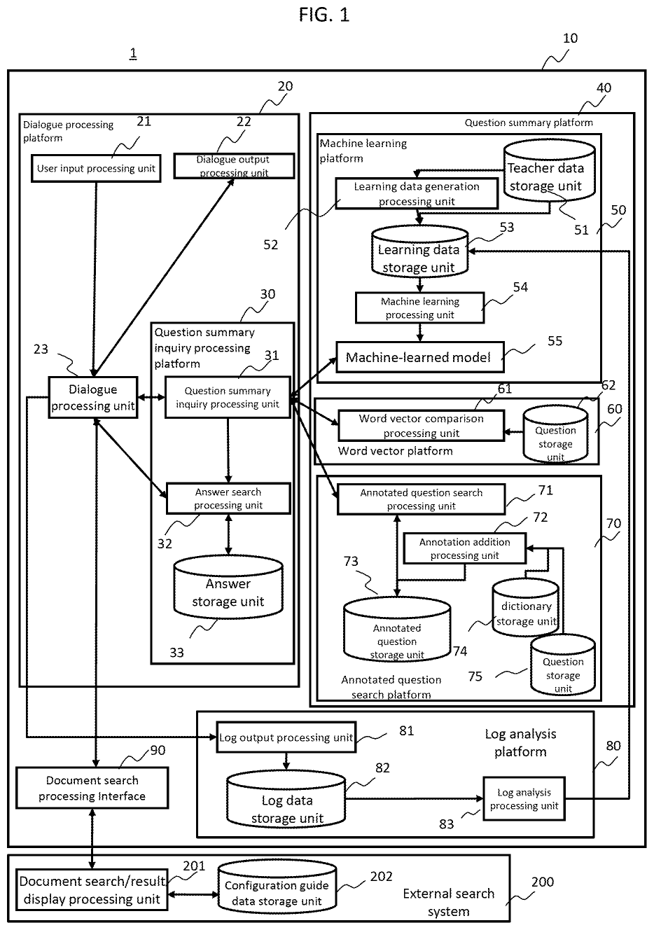

FIG. 1 is an overall configuration diagram of a computer system according to one embodiment.

A computer system 1 includes a question answering system 10 and an external search system 200 as an example of a search system. The question answering system 10 and the external search system 200 are coupled to each other via a network such as a wired local area network (LAN), a wireless LAN, and the Internet.

The question answering system 10 is configured with, for example, a general-purpose server or a personal computer (PC), and presents an answer to a question about operations of an estimation system or a question about product specifications. The question answering system 10 includes a dialog processing platform 20, a question summary platform 40, a log analysis platform 80, and a document search processing interface 90 as an example of a search processing mediating unit.

### [Dialog Processing Platform 20]

The dialog processing platform 20 includes a user input processing unit 21 as an example of a receiving unit and a type receiving unit, a dialog output processing unit 22, a dialog processing unit 23 as an example of a confirmation unit and a type determination unit, and a question summary inquiry processing platform 30. The user input processing unit 21, the dialog output processing unit 22, the dialog processing unit 23, and the question summary inquiry processing platform 30 are configured, for example, by a processor executing a program (a question answering program).

The user input processing unit 21 receives an input of a question or the like from a user. Here, the question input by the user is referred to as the input question. The user input processing unit 21 may receive an input from input devices such as a keyboard and a mouse, or may receive an input from a user's terminal (a user terminal) coupled thereto via a network.

The dialog output processing unit 22 displays and outputs, for example, information such as an answer to a question to the user. The dialog output processing unit 22 may cause a display device such as a display to display information, or may cause a user terminal coupled thereto via a network to display information.

The dialog processing unit 23 executes processes relating to information exchange (dialog) between the user and each unit of the question answering system 10. Specifically, the dialog processing unit 23 passes the input question received from the user through the user input processing unit 21 to the question summary inquiry processing platform 30 and/or the document search processing interface 90; the dialog processing unit 23 also receives an answer to the input question from the question summary inquiry processing platform 30 and/or the document search processing interface 90, and then passes the answer to the dialog output processing unit 22 for display.

### [Question Summary Inquiry Processing Platform 30]

The question summary inquiry processing platform 30 executes processes of mediating information exchange between the dialog processing unit 23 as an example of a presentation unit and the question summary platform 40.

The question summary inquiry processing platform 30 includes a question summary inquiry processing unit 31 as an example of a generation control unit, an answer search processing unit 32, and an answer storage unit 33. The question summary inquiry processing unit 31 and the answer search processing unit 32 are configured, for example, by the processor executing a program (a question answering program). The answer storage unit 33 is configured with, for example, a memory such as a random access memory (RAM), or a storage device (such as a hard disk drive (HDD) and a solid state drive (SSD)). The question summary inquiry processing unit 31 passes the input question passed from the dialog processing unit 23 to the question summary platform 40, and receives, from the question summary platform 40, a summary of question (question summary: an example of question information) for use in the search corresponding to the input question. The question summary inquiry processing unit 31 passes the question summary received from the question summary platform 40 to the answer search processing unit 32. The answer search processing unit 32 executes a process of searching the answer storage unit 33 for the corresponding answer with the question summary received from the question summary inquiry processing unit 31 as a key, and passes the answer obtained by the search to the dialog processing unit 23. The answer storage unit 33 holds data of pairs of the question summary and the answer corresponding to the question summary.

### [Question Summary Platform 40]

The question summary platform 40 includes a machine learning platform 50, a word vector platform 60, and an annotated question search platform 70.

The machine learning platform 50, the word vector platform 60, and the annotated question search platform 70 generate question summaries for the input question by respective different methods. Here, the machine learning platform 50 is an example of a first question information generating unit, and the word vector platform 60 is an example of a second question information generating unit and a vector comparison question information generating unit, and the annotated question search platform 70 is an example of a second question information generating unit and a component comparison question information generating unit. In this way, the reason for providing a plurality of different platforms for methods of generating question summaries is to improve the accuracy of the question summary. For example, if the learning data of the machine learning is less and the accuracy of the question summary by the machine learning platform 50 is poor, the use of a question summary generated by another platform, that is, the word vector platform 60 or the annotated question search platform 70 makes it possible to prevent the accuracy of the question summary from lowering.

It should be noted that, as different platforms from the machine learning platform, the word vector platform 60 and the annotated question search platform 70 are exemplified, but in addition to them or instead of them, a platform for generating a question summary by another method may be used. Further, as a different platform from the machine learning platform, either the word vector platform 60 or the annotated question search platform 70 may be used.

### [Machine Learning Platform 50]

The machine learning platform 50 includes a teacher data storage unit 51, a learning data generation processing unit 52, a learning data storage unit 53, a machine learning processing unit 54 as an example of a learning state determination unit, and a machine-learned model 55. The learning data generation processing unit 52, the machine learning processing unit 54, and the machine-learned model 55 are configured, for example, by the processor executing a program (a question answering program). The teacher data storage unit 51 and the learning data storage unit 53 is configured with a memory such as a RAM, or a storage device.

The teacher data storage unit 51 stores teacher data. The teacher data will be described later. The learning data storage unit 53 stores learning data. The learning data includes a type of data generated based on the teacher data and a type of data generated based on log data. The learning data generation processing unit 52 generates learning data from the teacher data in the teacher data storage unit 51 to store the learning data in the learning data storage unit 53.

The machine learning processing unit 54 performs machine learning (for example, deep learning) on a processing model to be learned (for example, a neural network model) by using the learning data stored in the learning data storage unit 53 to generate the machine-learned model 55. Here, the processing model is a model of receiving an input question and outputting (generating) a question summary which is a summary for the input question.

Specifically, the machine-learned model 55, which has been learned by the machine learning processing unit 54, for example, calculates a degree (confidence level) which indicates a likelihood of the question summary for the input question for each of the question summary candidates, and outputs a question summary candidate having the highest confidence level as the question summary of the input question.

### [Word Vector Platform 60]

The word vector platform 60 includes a word vector comparison processing unit 61 and a question storage unit 62. The word vector comparison processing unit 61 is configured by the processor executing a program (a question answering program). The question storage unit 62 is configured with a memory such as a RAM, or a storage device.

The question storage unit 62 stores questions of the question summary candidates. The word vector comparison processing unit 61 calculates a vector (word vector) for each word in the input question, identifies (generates), as the question summary, a question having a word vector that is the same as or similar to the word vector in the input question from the question storage unit 62, and outputs the identified question summary to the question summary inquiry processing unit 31. As a method of generating word vectors from sentences, a one-hot vector technique may be used.

### [Annotated Question Search Platform 70]

The annotated question search platform 70 includes an annotated question search processing unit 71, an annotation addition processing unit 72, an annotated question storage unit 73, a dictionary storage unit 74, and a question storage unit 75. The annotated question search processing unit 71 and the annotation addition processing unit 72 are configured by the processor executing a program (a question answering program). The annotated question storage unit 73, the dictionary storage unit 74, and the question storage unit 75 is configured with a memory such as a RAM, or a storage device.

The question storage unit 75 stores a sentence or sentences including various types of questions. The dictionary storage unit 74 stores information (phrase pattern) for identifying an important phrase (expression) to identify the content of the question from a sentence or sentences. The annotated question storage unit 73 stores questions (question summary candidates) to which an annotation indicating an important phrase for identifying the contents of the question is added.

The annotation addition processing unit 72 identifies a sentence corresponding to the phrase pattern stored in the dictionary storage unit 74 from the sentence or the sentences stored in the question storage unit 75, adds to the identified sentence an annotation indicating a part corresponding to the phrase pattern, and stores the resulting sentence in the annotated question storage unit 73. The processing by the annotation addition processing unit 72 may be executed, for example, before the processing executed by the annotated question search processing unit 71.

The annotated question search processing unit 71 analyzes the syntax of the input question, extracts an important (characteristic) phrase indicating the content of the question in the input question, searches the annotated question storage unit 73 for a question summary with the important phrase as a key to acquire (generate) the question summary, and outputs the resulting question summary to the question summary inquiry processing unit 31.

### [Log Analysis Platform 80]

The log analysis platform 80 includes a log output processing unit 81, a log data storage unit 82 as an example of a log storage unit, and a log analysis processing unit 83. The log output processing unit 81 and the log analysis processing unit 83 are configured by the processor executing a program (a question answering program). The log data storage unit 82 is configured with a memory such as a RAM, or a storage device.

The log data storage unit 82 stores log data. The structure of the log data will be described later. The log output processing unit 81 generates log data and stores the log data in the log data storage unit 82. The log analysis processing unit 83 identifies logs available as learning data from the log data, and stores the identified logs in the learning data storage unit 53.

### [Document Search Processing Interface 90]

The document search processing interface 90 mediates communication between the question answering system 10 and the external search system 200.

### [External Search System 200]

The external search system 200 is configured with, for example, a server apparatus or a PC. The external search system 200 includes a document search/result display processing unit 201 and a configuration guide data storage unit 202. The configuration guide data storage unit 202 stores documents (configuration guide data) defining product specifications (specifications and restrictions). The document search/result display processing unit 201 receives a search request, searches for a document corresponding to the search request, and transmits the document as the search result to the request source so that the document can be displayed.

Next, the data stored in the answer storage unit 33 will be described in detail.

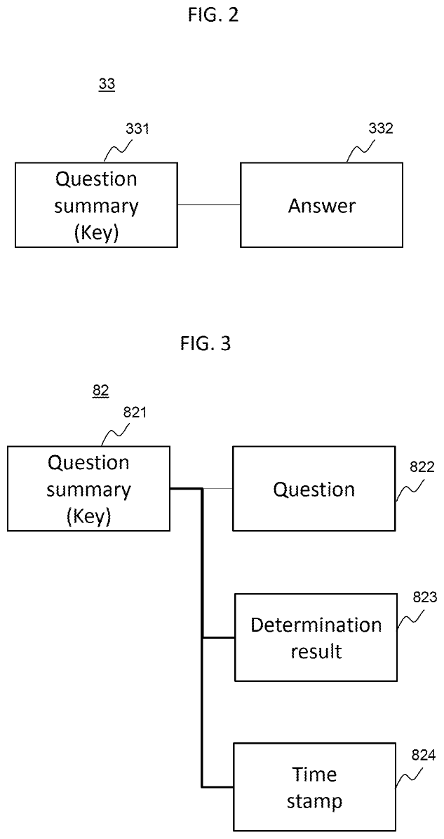

FIG. 2 is a diagram for describing a data structure of the answer storage unit according to the embodiment.

The answer storage unit 33 stores data in which a question summary 331 serving as a key and an answer 332 corresponding to the question summary are paired. With the answer storage unit 33, by using the question summary to be searched for as a key, an answer corresponding to the question summary can be searched for.

Next, the log data stored in the log data storage unit 82 will be described in detail.

FIG. 3 is a diagram for describing a data structure of a log in the log data storage unit according to the embodiment.

In the log data storage unit 82, log data in which a question 822, a determination result 823, and a time stamp 824 are associated with a question summary 821 serving as a key is stored. In the question 822, the input question used to generate the question summary 821 is stored. In the determination result 823, the result of user confirmation as to whether the content of the question summary 821 matches the intention of the input question (the meaning of the input question) is stored. In the time stamp 824, the date and time when the log data was created is stored.

Next, the teacher data stored in the teacher data storage unit 51 will be described in detail.

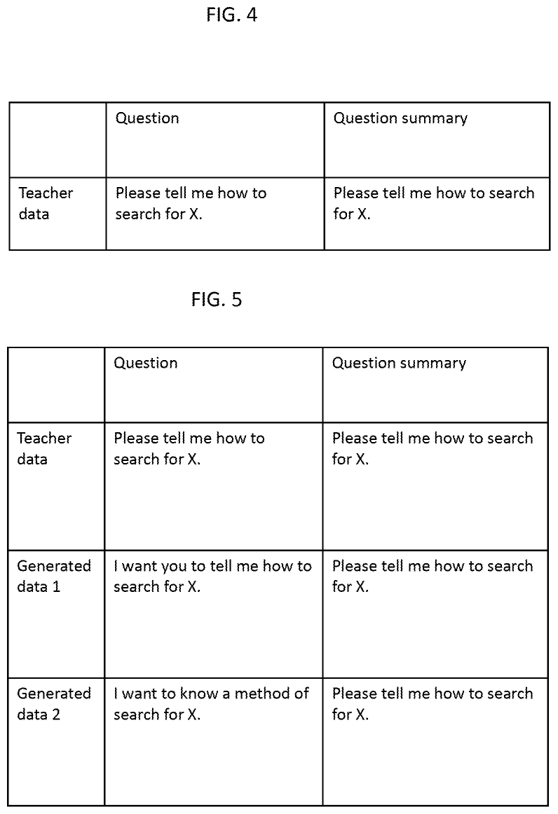

FIG. 4 is a diagram for describing a structure of teacher data in the teacher data storage unit according to the embodiment.

The teacher data storage unit 51 stores one or more pieces of teacher data in which a question and a summary corresponding to the question (question summary) are paired. Questions and question summaries in the teacher data are input by an administrator of the question answering system 10. It should be noted that in the teacher data, the question and the question summary are each registered as the same sentence.

Next, the learning data stored in the learning data storage unit 53 will be described in detail.

FIG. 5 is a diagram for describing learning data in the learning data storage unit according to the embodiment.

The learning data storage unit 53 stores a plurality of pieces of learning data in which a question and a summary corresponding to the question (question summary) are paired. Here, the learning data includes the same data as the teacher data, data generated based on the teacher data, and data generated based on the log data. For example, the data generated based on the teacher data is data in which a question similar to the question in the teacher data (in which, for example, a verb in the question sentence is changed to a similar expression) and the question summary in the teacher data are paired.

Next, the data stored in the question storage unit 75 will be described in detail.

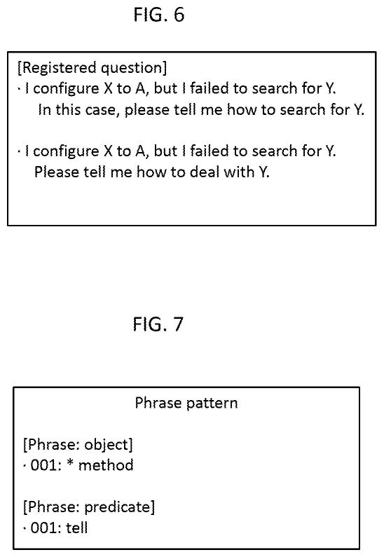

FIG. 6 is a diagram for describing an example of a question registered in the question storage unit according to the embodiment. FIG. 6 illustrates an example of questions which are not questions about product specifications.

The question storage unit 75 stores a plurality of questions in either a sentence or sentences.

Next, the data stored in the dictionary storage unit 74 will be described in detail.

FIG. 7 is a diagram for describing an example of data registered in the dictionary storage unit according to the embodiment. FIG. 7 illustrates an example of a phrase pattern used to identify a question summary from a question which is not a question about product specifications.

The dictionary storage unit 74 stores one or more phrase patterns to be used to identify a question summary from a question. An example of the phrase pattern includes a pattern in which information indicating a predicate (verb) included in a sentence corresponding to a question summary and information indicating the object of the predicate are paired. In the example of FIG. 7, as a phrase pattern, a pattern in which the predicate is “tell” and the object of the predicate is “how to *” (* is any character string) is stored. According to this phrase pattern, a sentence in which the predicate is “tell” or another conjugation thereof and the object is “how to *” indicates that it is a candidate for the question summary.

Next, the annotated question registered in the annotated question storage unit 73 will be described.

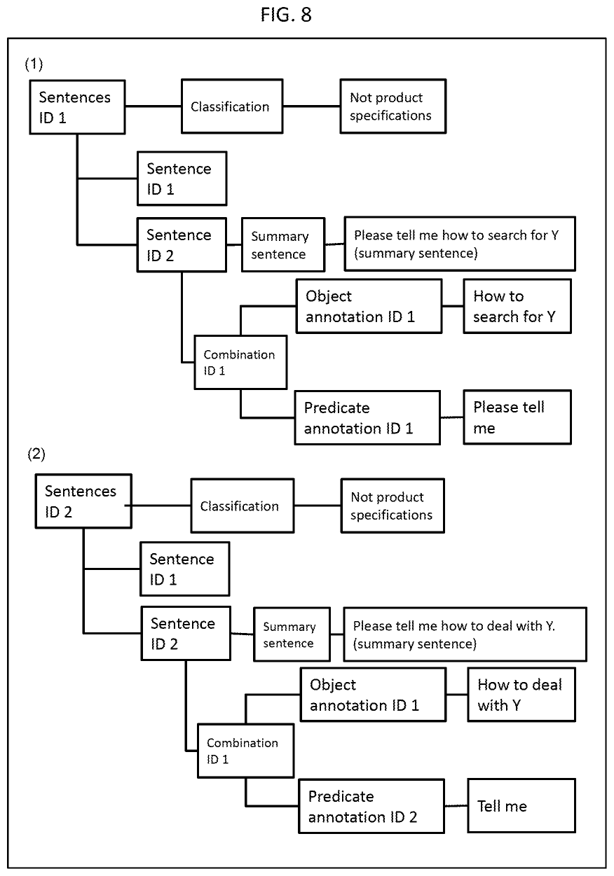

FIG. 8 is a diagram for describing an annotated question in the annotated question storage unit according to the embodiment. It should be noted that FIG. 8 is a diagram for describing annotated questions in the case where the question illustrated in FIG. 6 is stored in the question storage unit 75.

For the question sentences “I configure X to A, but failed to search for Y. Please tell me how to search for Y.” in FIG. 6, the annotation addition processing unit 72 analyzes the structure of each sentence in the sentences to identify the sentences as having the structure as illustrated in (1) of FIG. 8. At this time, if the sentences include a phrase pattern stored in the dictionary storage unit 74, the annotation addition processing unit 72 associates the phrase corresponding to the phrase pattern with an annotation (such as an object annotation ID1 and a predicate annotation ID1 in FIG. 8). Then, a sentence including the phrase pattern is set as a question summary corresponding to the phrase pattern. In this case, the annotation, the phrase associated with the annotation (in this example, predicate “please tell”, the object “how to search for Y”), and the sentence (summary) including them are stored as an annotated question in the annotated question storage unit 73.

Further, the question sentences “I configure X to A, but failed to search for Y. Please tell me how to deal with Y.” in FIG. 6 is analyzed as having a structure as illustrated in (2) of FIG. 8, and the annotation, the phrase associated with the annotation (in this example, predicate “tell”, the object “how to deal with Y”), and the sentence (summary) including them are stored as an annotated question in the annotated question storage unit 73.

Next, the data stored in the question storage unit 75 will be described in detail.

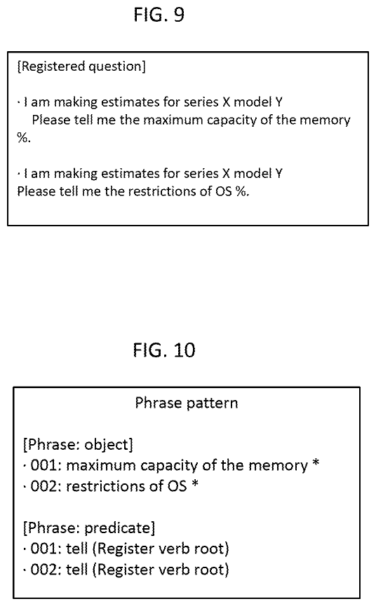

FIG. 9 is a diagram for describing an example of a question registered in the question storage unit according to the embodiment. FIG. 9 illustrates an example of questions about product specifications.

The question storage unit 75 stores a plurality of questions about product specifications in either a sentence or sentences. The question may be composed of one or more sentences. It should be noted that in question sentences about product specifications, for example, a variable part such as the maximum memory capacity and a type of OS that may change depending on questions, or the like is represented by a replacement symbol (“%” in FIG. 9). It should be noted that the replacement symbol will be replaced with the corresponding expression in the input question. For example, “%” in “Please tell me the maximum capacity of the memory %.” is replaced with “of series X model Y” if the input question is “Please tell me the maximum capacity of the memory of series X model Y.” The replacement based on the content of the input question makes it possible to require no registration of (the object of) the phrase pattern, for example, for each model of the series X, thereby reducing the load on the person in charge.

Next, another example of the data stored in the dictionary storage unit 74 will be described.

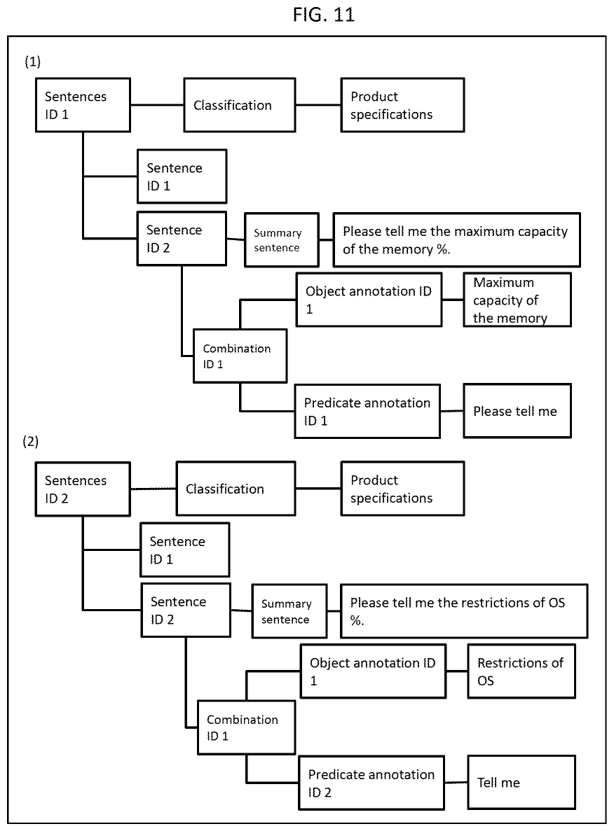

FIG. 10 is a diagram for describing an example of data registered in the dictionary storage unit according to the embodiment. FIG. 10 illustrates an example of a phrase pattern to be used to identify a question summary from a question about product specifications.

The dictionary storage unit 74 stores one or more phrase patterns to be used to identify a question summary from a question. An example of the phrase pattern includes a pattern in which information indicating a predicate included in a sentence corresponding to a question summary and information indicating the object of the predicate are paired. The pairing pattern is associated with the same identification number (“001”, “002”, etc. in FIG. 10), and as phrase patterns in the example of FIG. 10, a pattern (pattern of 001) in which the predicate is “tell” and the object of the predicate is “the maximum capacity of the memory *” (* is any character string) and a pattern (pattern of 002) in which the predicate is “tell” and the object of the predicate is “the restrictions of OS *” (* is any character string) are stored. According to this phrase pattern, a sentence in which the verb root of the predicate is “tell” and the object is “the maximum capacity of the memory *” becomes a candidate for the question summary, and a sentence in which the verb root of the predicate is “tell” and the object is “the restrictions of OS *” becomes a candidate for the question summary.

Next, the annotated question corresponding to the question about product specifications registered in the annotated question storage unit 73 will be described.

FIG. 11 is a diagram for describing an annotated question about product specifications in the annotated question storage unit according to the embodiment. It should be noted that FIG. 11 is a diagram for describing annotated questions in the case where the question illustrated in FIG. 9 is stored in the question storage unit 75.

For the question sentences “I am making estimates for series X model Y. Please tell me the maximum capacity of the memory %.” in FIG. 9, the annotation addition processing unit 72 analyzes the structure of each sentence in the sentences to identify the sentences as having the structure as illustrated in (1) of FIG. 11. At this time, if the sentences include a phrase pattern stored in the dictionary storage unit 74, the annotation addition processing unit 72 associates the phrase corresponding to the phrase pattern with an annotation (such as an object annotation ID1 and a predicate annotation ID1 in FIG. 11). Then, a sentence including the phrase pattern is set as a question summary corresponding to the phrase pattern. In this case, the annotation, the phrase associated with the annotation (in this example, the predicate “tell”, the object “the maximum capacity of the memory *”), and the sentence (summary) including them are stored as an annotated question in the annotated question storage unit 73.

Further, for the question sentences “I am making estimates for series X model Y. Please tell me the restrictions of OS %” in FIG. 9, the annotation, the phrase associated with the annotation (in this example, the predicate “tell”), the object (“the restrictions of OS *”), and the sentence (summary sentence) including them are stored as an annotated question in the annotated question storage unit 73.

Next, the processing operation in the computer system will be described.

### [Question Answering Process]

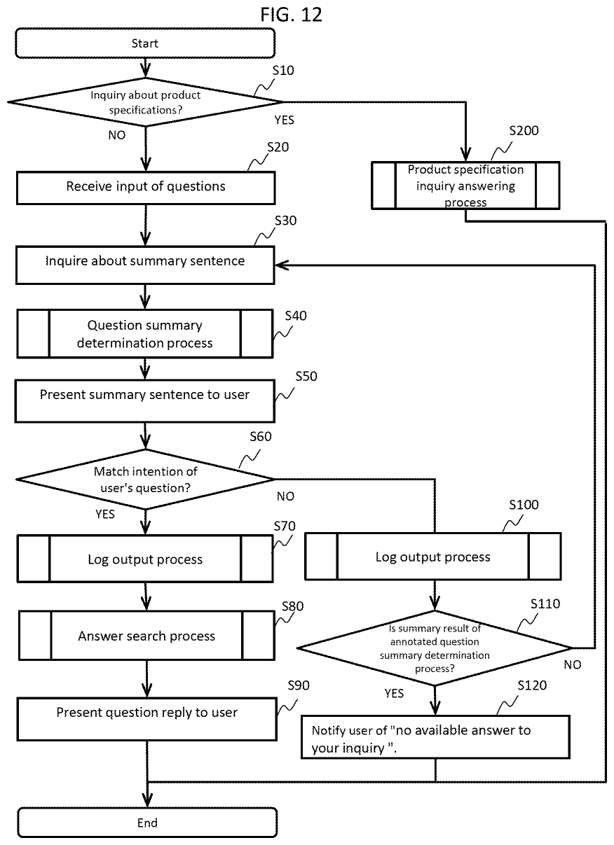

FIG. 12 is a flowchart of a question answering process according to the embodiment.

The question answering process is a process from when the user starts an input for a question to when the user receives an answer to the question or a notification that the no answer is available.

The user input processing unit 21 receives the type of inquiry (question) from the user, and the dialog processing unit 23 determines whether or not the type of question is an inquiry about product specifications (S10). Here, in the present embodiment, processing for inquiries relating to product specifications is set as the process that is not suitable for processing by the machine learning platform 50, and accordingly, the determination process is to determine whether or not the type of question is suitable for processing by the machine learning platform 50.

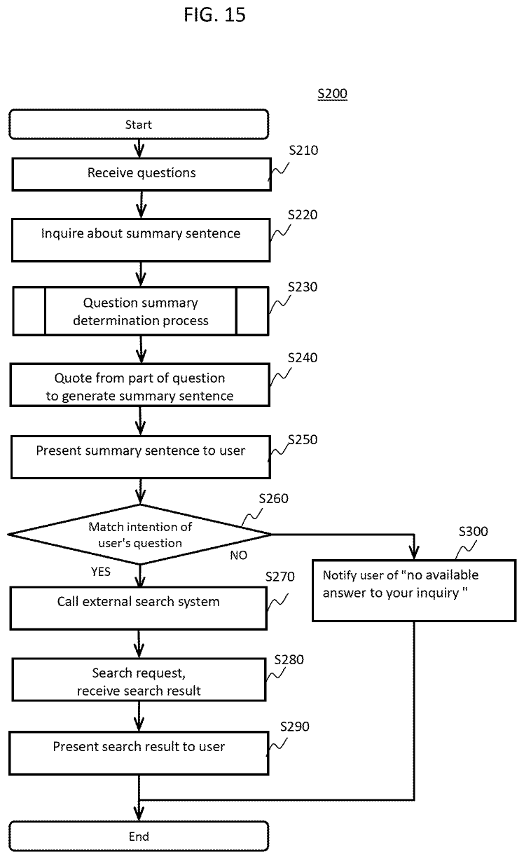

As a result, if it is determined that it is not an inquiry relating to product specifications (S10: NO), the dialog processing unit 23 advances the processing to step S20, whereas if it is determined that it is an inquiry relating to product specifications (S10: YES), it means that processing for this inquiry is a process that is not suitable for the processing by the machine learning platform 50 and accordingly, the dialog processing unit 23 executes a product specification inquiry answering process (see FIG. 15) (S200).

In step S20, the dialog processing unit 23 receives an input of a question via the user input processing unit 21. Then, the dialog processing unit 23 instructs the question summary inquiry processing unit 31 to inquire a question summary for the input question. When receiving the instruction, the question summary inquiry processing unit 31 inquires generation of the question summary (summary sentence) for the input question to the platform (any one of 50, 60, and 70) according to the instruction (S30).

For example, immediately after receiving the input question, the dialog processing unit 23 instructs to inquire the question summary to the machine learning platform 50; if the question summary obtained by the inquiry about the question summary to the machine learning platform 50 is not appropriate, the dialog processing unit 23 instructs to inquire the question summary to the word vector platform 60; if the question summary obtained by the inquiry about the question summary to the word vector platform 60 is not appropriate, the dialog processing unit 23 instructs to inquire the question summary to the annotated question platform 70.

When receiving the inquiry about the generation of the question summary from the question summary inquiry processing unit 31, the platform executes a question summary determination process (S40).

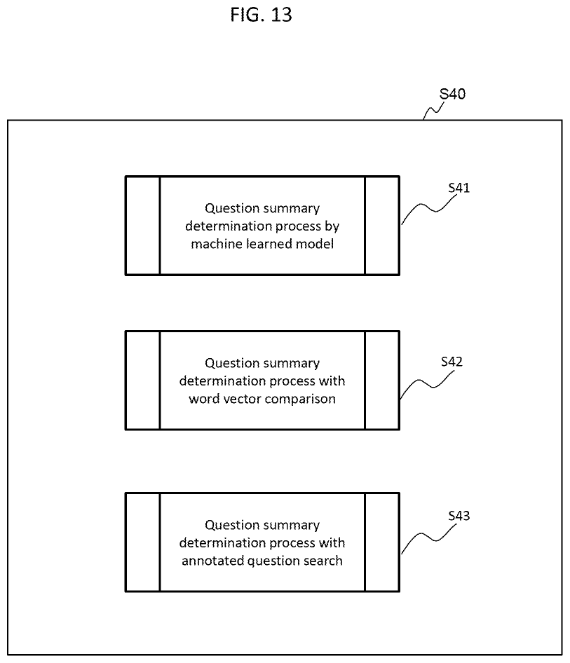

FIG. 13 is a flowchart of a question summary determination process according to the embodiment.

In the question summary determination process, one of the following processes is executed according to an instruction: a question summary determination process of a machine-learned model executed by the machine learning platform 50 (S41), a question summary determination process with word vector comparison executed by the word vector platform 60 (S42), and a question summary determination process with the annotated question search process by the annotated question search platform 70 (S43).

### [Question Summary Determination Process of Machine-Learned Model]

In the question summary determination process of the machine-learned model in step S41, the machine-learned model 55 of the machine learning platform 50 receives the input question, generates a question summary, and passes the generated question summary to the dialog processing unit 23 via the question summary inquiry processing unit 31.

[Question Summary Determination Process with Word Vector Comparison]

In the question summary determination process with word vector comparison in step S42, the word vector comparison processing unit 61 of the word vector platform 60 generates as a question summary a question having a word vector that is the same as or similar to the word vector in the input question from the question storage unit 62, and passes the generated summary question to the dialog processing unit 23 via the question summary inquiry processing unit 31.

[Question Summary Determination Process with Annotated Question Search]

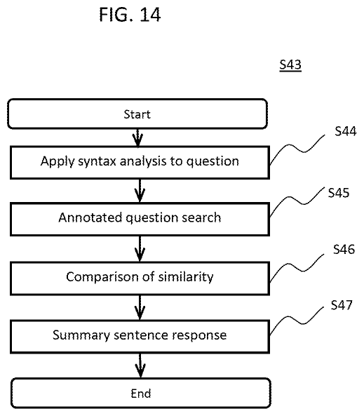

In the question summary determination process with annotated question search (annotated question summary determination process: see FIG. 14) in step S43, the annotated question search processing unit 71 of the annotated question search platform 70 analyzes the syntax of the input question, extracts an important (characteristic) phrase indicating the content of the question in the input question, searches the annotated question storage unit 73 for a question summary with the important phrase as a key to generate the question summary, and passes the generated question summary to the dialog processing unit 23 via the question summary inquiry processing unit 31.

Returning to the explanation of FIG. 12, after the question summary determination process is executed, the dialog processing unit 20 transfers the question summary to the dialog output processing unit 22, and the dialog output processing unit 22 presents (outputs and displays) the question summary to the user (S50).

Then, the dialog processing unit 23 receives a confirmation result as to whether or not the presented question summary is appropriate, that is, a confirmation result as to whether or not the question summary matches the intention of the user's question, from the user via the user input processing unit 21, and determines based on the confirmation result whether or not the question summary matches the intention of the user, that is, whether or not the question summary is appropriate (S60).

As a result, if it is determined that the question summary matches the intention of the user (the question summary is appropriate) (S60: YES), the dialog processing unit 23 instructs the log output processing unit 81 to output log data. When receiving the instruction, the log output processing unit 81 generates log data including the input question, the question summary, and a determination result as to whether or not the question summary matches the intention of the user's question (here, the determination result indicating that they match) to output the log data to the log data storage unit 82 (S70).

Then, the dialog processing unit 23 passes the question summary to the answer search processing unit 32 and also instructs the answer search processing unit 32 to search for an answer with the question summary as a key. The answer search processing unit 32 searches the answer storage unit 33 for an answer with the question summary as a key and passes the answer as the search result to the dialog processing unit 23 (S80). The dialog processing unit 23 passes the passed answer to the dialog output processing unit 22. The dialog output processing unit 22 presents the answer to the user by displaying it on a display or the like (S90), and ends the processing.

On the other hand, if it is not determined that the question summary matches the intention of the user (S60: NO), it means that the question summary is not appropriate and accordingly, the dialog processing unit 23 instructs the log output processing unit 81 to output log data. When receiving the instruction, the log output processing unit 81 generates log data including the input question, the question summary, and a determination result as to whether or not the question summary matches the intention of the user's question (here, the determination result indicating that they do not match) to output the log data to the log data storage unit 82 (S100).

Then, the dialog processing unit 23 determines whether or not the question summary determined not to match the intention of the user is the question summary obtained by the annotated question summary determination process, that is, whether or not the question summary determination process to be executed last has been executed (S110).

As a result, if it is determined that the question summary determined not to match the intention of the user is not the question summary generated by the annotated question summary determination process (S110: NO), the dialog processing unit 23 advances the processing to step S30 in order to execute the question summary determination process in the next turn. On the other hand, if it is determined that the question summary determined not to match the intention of the user is the question summary generated by the annotated question summary determination process (S110: YES), it means that the question summaries are generated by all the question summary determination processes and also any of the question summaries does not match the intention of the user, and accordingly, the dialog processing unit 23 notifies the user of a message of “no available answer to your inquiry” (no-answer reply) (S120) via the dialog output processing unit 22, and ends the processing.

Next, the annotated question summary determination process (S43) will be described in detail.

FIG. 14 is a flowchart of the question summary determination process with annotated question search according to the embodiment.

The annotated question search processing unit 71 decomposes the user's input question into single sentences by a syntactic analysis technique, and thereafter, decomposes each of the single sentences into items of subject and object (S44). Then, the annotated question search processing unit 71 searches the annotated question storage unit 73 for annotated questions with the value of the decomposed item as a key (S45).

Then, the annotated question search processing unit 71 calculates a similarity between the item obtained from the input question and the item of each of the annotated questions obtained by the search by using a technique such as the cosine similarity, and compares the calculated similarities (S46). Then, the annotated question search processing unit 71 sends the question summary of an annotated question having the highest similarities to the items obtained from the input question and the syntactic analysis result of the question summary to the question summary inquiry processing unit 31 (S47), and ends the processing.

Next, the product specification inquiry answering process (S200) will be described in detail.

FIG. 15 is a flowchart of the product specification inquiry answering process according to the embodiment.

First, the dialog processing unit 23 receives an input of a question about product specifications via the user input processing unit 21 (S210). Then, the dialog processing unit 23 inquires generation of the question summary (summary sentence) for the input question to the annotated question search platform 70 via the question summary inquiry processing unit 31 (S220).

The annotated question search platform 70 executes the question summary determination process with annotated question search (S230). As a result, the annotated question search processing unit 71 of the annotated question search platform 70 passes the generated question summary to the question summary inquiry processing unit 31.

The question summary inquiry processing unit 31 replaces the variable in the question summary (for example, “%” in FIG. 9) with the corresponding part (“of model Y”) in the input question (for example, “Please tell me the maximum capacity of the memory of model Y”) to generate a final question summary (“Please tell me the maximum capacity of the memory of model Y”), and passes the final question summary to the dialog processing unit 23 (S240).

Then, the dialog processing unit 23 transfers the question summary to the dialog output processing unit 22, and the dialog output processing unit 22 presents (outputs and displays) the question summary to the user (S250).

Then, the dialog processing unit 23 receives a confirmation result as to whether or not the presented question summary is appropriate, that is, a confirmation result as to whether or not the question summary matches the intention of the user's question, from the user via the user input processing unit 21, and determines based on the confirmation result whether or not the question summary matches the intention of the user (S260).

As a result, if it is determined that the question summary matches the intention of the user (S260: YES), the dialog processing unit 23 passes the syntactic analysis result of the question summary to the document search processing interface 90. The document search processing interface 90 calls the document search/result display processing unit 201 of the external search system 200, and passes the syntactic analysis result of the question summary thereto (S270). As a result, the called document search/result display processing unit 201 searches the configuration guide data storage unit 202 for a document with the syntactic analysis result of the question summary as a key, and will return the search result to the document search processing interface 90.

The document search processing interface 90 receives the search result returned from the external search system 200, and passes the search result to the dialog processing unit 23 (S280). The dialog processing unit 23 passes the passed search result to the dialog output processing unit 22. The dialog output processing unit 22 presents the search result to the user by displaying it on a display or the like (S290), and ends the processing.

On the other hand, if it is determined that the question summary does not match the intention of the user (S260: NO), the dialog processing unit 23 notifies the user of a message of “no available answer to your inquiry” (S300) via the dialog output processing unit 22, and ends the processing.

Next, the annotated question summary determination process (S230) will be described in detail.

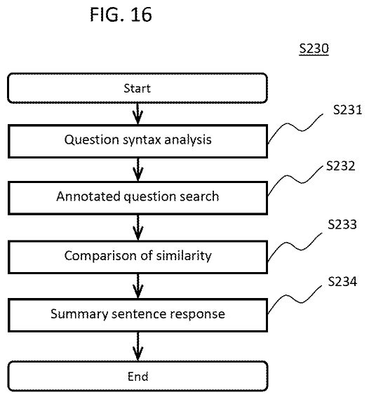

FIG. 16 is a flowchart of the question summary determination process with annotated question search according to the embodiment.

The annotated question search processing unit 71 decomposes the user's input question into single sentences by a syntactic analysis technique, and thereafter, decomposes each of the single sentences into items of subject and object (S231). Then, the annotated question search processing unit 71 searches the annotated question storage unit 73 for annotated questions with the value of the decomposed item (for example, “Please tell me”) as a key (S232).

Then, the annotated question search processing unit 71 calculates a similarity between the item obtained from the input question and the item of each of the annotated questions obtained by the search by using a technique such as the cosine similarity, and compares the calculated similarities (S233). Then, the annotated question search processing unit 71 sends the question summary of an annotated question having the highest similarities to the items obtained from the input question and the syntactic analysis result of the question summary to the question summary inquiry processing unit 31 (S234), and ends the processing.

### [Machine Learning Process]

Next, the machine learning process will be described.

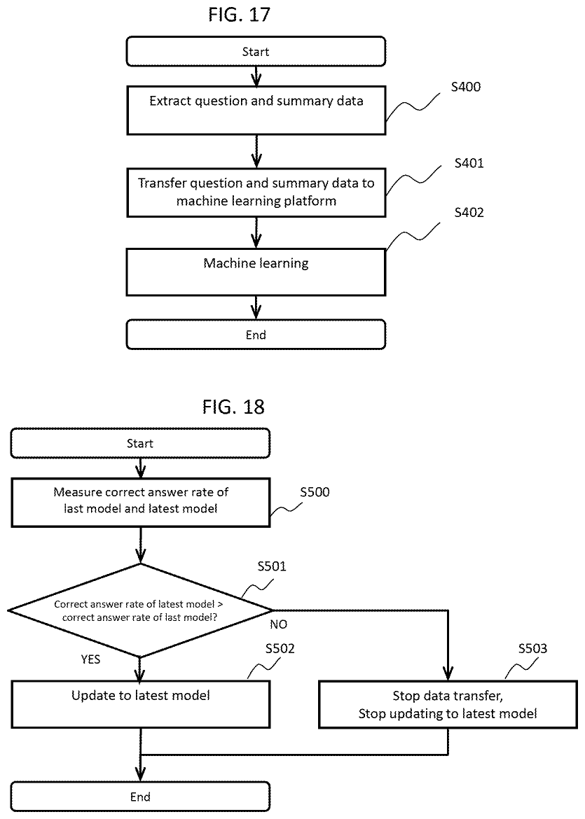

FIG. 17 is a flowchart of the machine learning process according to the embodiment.

The machine learning process is executed, for example, each time a predetermined time elapses, or when the data amount of log data in the log data storage unit 82 reaches a predetermined amount, or the like.

First, the log analysis processing unit 83 extracts, from the log data storage unit 82, a set of the question summary of the log data including the determination result indicating that it matches the intention of the question and the question from which the question summary originates (S400), transfers the set to the learning data storage unit 53 of the machine learning platform 50 to store it as learning data (S401).

Thereafter, the machine learning processing unit 54 executes machine learning for the machine-learned model 55 by using the learning data stored in the learning data storage unit 53 (S402).

Thus, even if there are less learning data prepared in advance, it is possible to increase learning data by using the log data of the question summary generated by any one of the platforms (50, 60, 70) of the question summary platform 40, and accordingly, improve the accuracy of inference of the machine-learned model 55.

### [Over-Learning Elimination Process]

For example, if the amount of learning data used for learning increases too much, over-learning which reduces the accuracy of inference of the machine-learned model 55 may occur. In the present embodiment, in order to eliminate occurrence of such over-learning, an over-learning elimination process is executed.

FIG. 18 is a flowchart of the over-learning elimination process according to the embodiment.

The over-learning elimination process is executed, for example, immediately after the machine learning process is executed.

The machine learning processing unit 54 measures a correct answer rate of each of the machine-learned model (last model) until a new machine learning process is performed and the machine-learned model (latest model) obtained by the new machine learning process, by using the learning data in the learning data storage unit 53 (S500). Then, the machine learning processing unit 54 determines whether or not the correct answer rate of the latest model is greater than the correct answer rate of the last model (S501).

As a result, if it is determined that the correct answer rate of the latest model is greater than the correct answer rate of the last model (S501: YES), it means that the latest model has a higher accuracy, and accordingly, the machine learning processing unit 54 updates the machine-learned model 55 to the latest model (S502), and ends the processing.

On the other hand, when it is determined that the correct answer rate of the latest model is not greater than the correct answer rate of the last model (S501: NO), over-learning may have occurred on the latest model, and accordingly, the machine learning processing unit 54 does not update the machine-learned model 55 to the latest model to leave it as it is, stops the transfer of the learning data from the log data storage unit 82 by the log analysis processing unit 83 (S503), and ends the processing.

The over-learning elimination process can appropriately prevent the machine-learned model 55 from being over learned.

### [Document Search Outside Advance Preparation Data]

The document search process without advance preparation data in the question answering system 10 will be described.

For example, in the question answering process in FIG. 12, when the presented answer is not obtained (for example, NO at S110), the dialog processing unit 23 can couple to the external search system 202 via the document search interface 90 to obtain an answer to the question from the external search system 202. In this way, even if the question answering system 10 has not learned the data to be answered, it is possible to search for the answer without preparing in advance.

As described above, the computer system of the above-described embodiment is configured to execute the question summary generation process by machine learning and the other question summary generation processes, and if an appropriate question summary cannot be obtained by the question summary generation process by machine learning, a question summary can be used by the other question summary generation processes. Accordingly, even if the question summary generation process by machine learning cannot provide sufficient accuracy because of less learning data, it is possible to improve the accuracy of the question summary and as a result to improve the accuracy of the answer. Further, even if the question summary generation process by machine learning cannot provide sufficient accuracy because of less learning data, it is possible to improve the accuracy of the question summary and as a result to reduce preparation costs without enriched initial learning data. Further, since the question summary generated by each of the question summary generation processes can be used as new learning data during the actual use, costs for generating learning data can be reduced. Further, in the above-described embodiment, since the user is presented with confirmation as to whether the question summary is appropriate, the possibility of giving the user a misunderstanding by presenting an answer to an incorrect question to the user can be reduced.

### [Switching of Multiple Question Answering Systems]

Next, a computer system according to a first modification will be described.

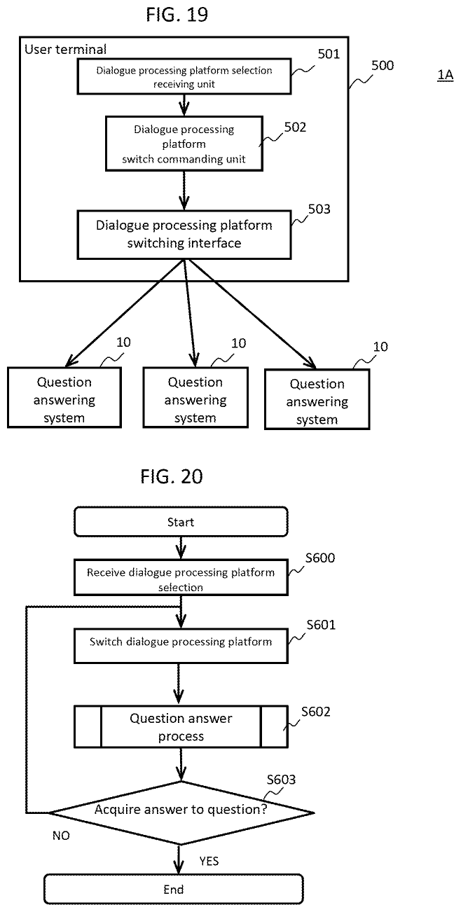

FIG. 19 is an overall configuration diagram of the computer system according to the first modification.

A computer system 1A according to the first modification is a system including a plurality of question answering systems 10. It should be noted that the similar constituent parts to those of the computer system 1 according to the above-described embodiment are denoted by the same reference symbols.

The computer system 1A is an example of a question answering integrated system, and includes a plurality of question answering systems 10 and a user terminal 500. Although the basic configuration of the question answering system 10 is the same as that of the question answering system 10 of the above-described embodiment, the data stored in the answer storage unit 33, the teacher data storage unit 51, the learning data storage unit 53, the dictionary storage unit 74, and the question storage unit 75 are prepared for each of the question answering systems 10. That is, depending on the question answering system 10, specialty questions may differ or answers may differ, and also in some case, a question that could not be answered by one question answering system 10 can be answered by another question answering system 10.

The user terminal 500 is configured with, for example, a computer such as a PC, and includes a dialog processing platform selection receiving unit 501, a dialog processing platform switching commanding unit 502 as an example of a request destination switching unit, and a dialog processing platform switching interface 503. These functional units are configured, for example, by a processor of the user terminal 500 executing a program. It should be noted that the functions of the user terminal 500 may be provided in the question answering system 10.

The dialog processing platform selection receiving unit 501 receives designation of the question answering system 10 to be used from the user. The dialog processing platform switching commanding unit 502 issues a command of switching the question answering system 10 to be interacted (coupled) depending on the designation of the question answering system 10 by the user received from the dialog processing platform selection receiving unit 501, and the answering state of the question answering system 10. The dialog processing platform switching interface 503 executes a process of switching the question answering system 10 to be coupled to the user terminal 500 in accordance with the command from the dialog processing platform switching commanding unit 502.

Next, the processing operation of the computer system 1A according to the first modification will be described.

FIG. 20 is a flowchart of overall processing according to the first modification.

First, the dialog processing platform selection receiving unit 501 receives designation of the question answering system 10 to be used from the user (S600).

Then, the dialog processing platform switching commanding unit 502 issues a command of switching the question answering system 10 to be used depending on the designation of the question answering system 10 received from the dialog processing platform selection receiving unit 501 and the answering state of the question answering system 10; the dialog processing platform switching interface 503 switches the question answering system 10 to be coupled in accordance with the command (S601). In the present example, the dialog processing platform switching commanding unit 502 initially couples to the question answering system 10 designated by the user, and when failing to receive an answer to the question from the coupled question answering system 10, the dialog processing platform switching commanding unit 502 couples to another question answering system 10.

After the dialog processing platform switching commanding unit 502 couples to the question answering system 10, the question answering process illustrated in FIG. 12 is executed by the coupled question answering system 10 (S602). Then, the dialog processing platform switching commanding unit 502 determines whether or not an answer to the question can be acquired by the question answering process (S603).

As a result, if the answer to the question can be acquired by the question answering process (S603: YES), the dialog processing platform switching commanding unit 502 ends the processing, whereas if an answer to the question cannot be acquired by the question answering process, for example, if a no-answer reply is received in step S120 in FIG. 12 (S603: NO), the dialog processing platform switching commanding unit 502 advances the processing to step S601 to switch the coupled question answering system 10 and continue the subsequent process.

According to this process, when the answer to the question cannot be acquired, the question answering system 10 can be appropriately switched, and thus, the possibility of obtaining an answer to the question can be improved.

It should be noted that a method of determining the question answering system 10 to be coupled may be of following the user's designation at all times, or may be of switching the coupling destination according to the content of the question with types of specialty questions of each question answering system 10 and the like being grasped beforehand.

### [Seamless Takeover to Manned Response System]

Next, a computer system according to a second modification will be described.

The computer system according to the second modification is a computer system that allows takeover to a manned response system for answering a question by a person (service desk system) when the question answering system 10 cannot answer the question.

The computer system includes a service desk system as an example of a manned response system. In addition, the question answering system 10 further includes a takeover interface for coupling from the question answering system to the service desk system. The takeover interface corresponds to an example of a takeover unit.

Next, the processing operation of the computer system according to the second modification will be described.

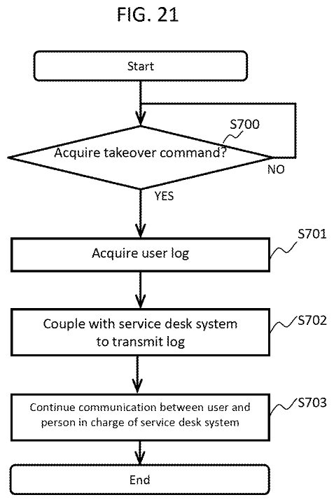

FIG. 21 is a flowchart of a system takeover process according to the second modification.

The takeover interface determines whether or not a takeover command has been acquired (S700). Here, the takeover command may be an explicit command from the user, or may be the no-answer reply in step S120 of FIG. 12.

As a result, if the takeover command has not been acquired (S700: NO), the takeover interface advances the processing to step S700, whereas if the takeover command is acquired (S700: YES), the takeover interface acquires log data (a set of the question and the obtained question summary) involving the user from the log data storage unit 82 (S701), couples to the service desk system, and transmits the log data (S702). As a result, in the service desk system, the content of the log data is displayed so that a person in charge of the service desk system can confirm it.

Then, the takeover interface allows the user and the person in charge of the service desk system to continue communication capable of exchanging voice, letters, and the like (S703), and ends the processing.

This allows seamless takeover from the question answering system 10 to the service desk system. In other words, according to this system takeover process, it is possible to easily and appropriately take over the situation of the question executed by the user to the person in charge of the service desk system.

It should be noted that the present invention is not limited to the above-described embodiments, and modified implementations are possible as appropriate without departing from the scope of the present invention.

For example, in the above-described embodiments, two question summary determination processes can be executed as the question summary determination process, but as a process other than the question summary determination process with the machine-learned model, one question summary determination process may be used, or three or more question summary determination processes may be executable.

In the above-described embodiments, one of the plurality of question summary determination processes is executed, and when an appropriate question summary cannot be obtained, another question summary determination process is executed to execute the question summary determination processes in order. However, the present invention is not limited to this. For example, a plurality of question summary determination processes are executed to generate a plurality of question summaries, and an appropriate question summary may be selected from among the question summaries.

Further, in the above embodiments, first, a question summary by the question summary determination process with the machine-learned model is provided to the user, and thereafter, a question summary by another question summary determination process is provided to the user. However, the present invention is not limited to this. The order of providing the question summary to the user may be set to any order. For example, when a question summary is generated by the question summary determination process with the machine-learned model, and if a confidence level (numerical value indicating the probability of being inferred as the question summary in the machine-learned model) for the generated question summary is equal to or smaller than a predetermined value, a question summary by another question summary determination process may be presented to the user first. This makes it possible to present the question summary by another question summary determination process to the user prior to the question summary which would have low accuracy in the question summary determination process with the machine-learned model.

Further, in the above embodiments, some or all of the processes executed by the processor may be executed by a hardware circuit. Further, the program in the above embodiments may be installed from a program source. The program source may be a program distribution server or a storage medium (for example, a portable storage medium).

What is claimed is:

1. A question answering system for presenting an answer to an input question, comprising:
a receiving unit configured to receive the input question;
a first question information generating unit configured to generate question information for searching corresponding to the received input question by using a learned model for inferring question information from an input question;
a second question information generating unit configured to generate question information for searching corresponding to the received input question without using the learned model;
an answer search processing unit configured to search for an answer corresponding to the question information by using the question information generated by at least one of the first question information generating unit and the second question information generating unit; and
a presentation unit configured to present the answer obtained through the searching.

2. The question answering system according to claim 1, wherein the second question information generating unit includes at least one of a vector comparison question information generating unit and a component comparison question information generating unit, the vector comparison question information generating unit is configured to identify a question candidate having a vector relating to a word that is the same as or similar to the input question among from question candidates serving as candidates for question information prepared in advance and to generate the identified question candidate as question information, and the component comparison question information generating unit is configured to identify a question candidate including an expression that is the same as or similar to an expression of a predetermined component of the input question among from question candidates serving as candidates for question information and to generate the identified question candidate as the question information.

3. The question answering system according to claim 1, further comprising a confirmation unit configured to, when the question information is generated by at least one of the first question information generating unit and the second question information generating unit, receive a confirmation as to whether or not the generated question information is appropriate from a user who inputs the input question,
wherein the answer search processing unit is configured to search for an answer by using the question information indicated in the confirmation received by the confirming unit as being appropriate.

4. The question answering system according to claim 2, wherein the first question information generating unit is configured to generate the question information prior to the second question information generating unit, and
the second question information generating unit is configured to generate the question information when the confirmation unit receives the confirmation indicating that the question information generated by the first question information generating unit is not appropriate.

5. The question answering system according to claim 2, wherein the first question information generating unit is configured to generate the question information prior to the second question information generating unit,
the confirmation unit is configured to cause a confirmation as to whether to be appropriate for the question information generated by the second question information generating unit prior to the question information generated by the first question information generating unit when a confidence level in inference by the learned model for the question information generated by the first question information generating unit is equal to or smaller than a predetermined value, and
the confirmation unit is configured to, when receiving the confirmation indicating that the question information is not appropriate, cause a confirmation as to whether the question information generated by the first question information generating unit is appropriate.

6. The question answering system according to claim 1, further comprising:
a log storage unit configured to store a log in which the input question and the question information indicated in the confirmation received by the confirming unit as being appropriate are associated with each other; and
a machine learning processing unit configured to learn the learned model by using the log stored in the log storage unit.

7. The question answering system according to claim 1, further comprising:
a learning state determination unit configured to measure a correct answer rate for predetermined learning data with the learned model, to measure a correct answer rate for the predetermined learning data with a new learned model generated by performing a new leaning on the learned model, and to determine whether or not the correct answer rate with the new leaned model is smaller than the correct answer rate with the learned model,
wherein the first question information generating unit is configured to use the learned model as it is when the learning state determination unit determines that the correct answer rate with the new leaned model is smaller than the correct answer rate with the learned model, and the first question information generating unit is configured to use the new learned model when the learning state determination unit does not determine that the correct answer rate with the new leaned model is smaller than the correct answer rate with the learned model.

8. The question answering system according to claim 1, further comprising a search processing mediating unit configured to, when appropriate question information corresponding to the input question fails to be generated, transmit the input question to a predetermined search system, receive a search result from the search system, and present the search result.

9. The question answering system according to claim 1, further comprising:
a log storage unit configured to store a log in which the input question and the question information generated by the first question information generating unit and the second question information generating unit are associated with each other; and
a takeover unit configured to transmit a log corresponding to the input question stored in the log storage unit to a manned response system when appropriate question information corresponding to the input question fails to be generated.

10. The question answering system according to claim 1, further comprising:
a type receiving unit configured to receive a type of the input question;
a type determination unit configured to determine whether or not the type received by the type receiving unit is suitable for a process of generating the question information corresponding to the input question by the first question information generating unit; and
a generation control unit configured to cause the second question information generating unit to generate the question information without generating the question information by the first question information generating unit when the type determination unit determines that the type is not suitable for the process of generating the question information corresponding to the input question.

11. A question answering processing method in a question answering system for presenting an answer to an input question, comprising:
receiving the input question;
performing at least one of a first method of generating question information for searching corresponding to the received input question by using a learned model for inferring question information from an input question and a second method of generating question information for searching corresponding to the received input question without using the learned model;
searching for an answer corresponding to the question information by using the question information generated by at least one of the first method and the second method; and
presenting the answer obtained through the searching.

12. A question answering integrated system comprising a plurality of question answering systems each for presenting an answer to an input question,
wherein each of the question answering systems comprise a receiving unit configured to receive the input question;
a first question information generating unit configured to generate question information for searching corresponding to the received input question by using a learned model for inferring question information from an input question;
a second question information generating unit configured to generate question information for searching corresponding to the received input question without using the learned model;
a confirmation unit configured to, when the question information is generated by at least one of the first question information generating unit and the second question information generating unit, receive a confirmation as to whether or not the generated question information is appropriate from a user who inputs the input question;
an answer search processing unit configured to search for an answer corresponding to the question information by using the question information indicated in the confirmation received by the confirming unit as being appropriate; and
a presentation unit configured to present the answer obtained through the searching, and
the question answering integrated system comprises
a request destination switching unit configured to, when any one of the question answering systems fails to generate appropriate question information corresponding to the input question, output the input question to another question answering system.
